(19) United States
(12) Patent Application Publication
(10) Pub. No.: US 2008/0167902 A1
(43) Pub. Date: Jul. 10, 2008

(54) SYSTEMS AND METHODS FOR PATIENT AND STUDY DATA EXPORT FROM A PACS DATABASE

(75) Inventors: Kengo Baba, Evanston, IL (US); Benjamin D. Novatzky, Oak Park, IL (US); Yanhua Zhang, Rolling Meadows, IL (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/619,865

(22) Filed: Jan. 4, 2007

(51) Int. Cl. G06Q 50/00

(52) U.S. Cl. 705/3

(57) ABSTRACT

Certain embodiments of the present invention provide a user interface including a representation of a plurality of data items and an export control. Each data item in the plurality of data items represents at least one of patient information and study information stored in a picture archiving and communication system (PACS). The export control allows a user to export one or more of the plurality of data items.

### BACKGROUND OF THE INVENTION

The present invention generally relates to medical information systems. In particular, the present invention relates to systems and methods for patient and study data export from a picture archiving and communication system (PACS) database.

Healthcare environments, such as hospitals or clinics, include clinical information systems, such as hospital information systems (HIS) and radiology information systems (RIS), and storage systems, such as picture archiving and communication systems (PACS). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

PACS connect to medical diagnostic imaging devices and employ an acquisition gateway (between the acquisition device and the PACS), storage and archiving units, display workstations, databases, and sophisticated data processors. These components are integrated together by a communication network and data management system. A PACS has, in general, the overall goals of streamlining health-care operations, facilitating distributed remote examination and diagnosis, and improving patient care.

A typical application of a PACS system is to provide one or more medical images for examination by a medical professional. For example, a PACS system can provide a series of x-ray images to a display workstation where the images are displayed for a radiologist to perform a diagnostic examination. Based on the presentation of these images, the radiologist can provide a diagnosis. For example, the radiologist can diagnose a tumor or lesion in x-ray images of a patient's lungs.

A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools.

As discussed above, PACS provide functionality to store and display various pieces of patient and/or study information. For example, a PACS may display a diagnostic report, exam notes, and key image notes. These pieces of information may be displayed on the monitor screen of a PACS workstation, for example. The purpose of a PACS application is to provide the information and medical images necessary for a radiologist or other healthcare provider to diagnose the patient's health state.

In current systems, there are a number of functionalities to create, save, and display various pieces of patient and/or study information in a PACS. After locating a desired piece of information, it may be exported or printed individually. For example, FIGS. 1A-1E illustrate various interfaces in a PACS application handling different forms of patient and/or study information.

FIG. 1A illustrates an exam notes dialog in a current PACS system. The exam notes dialog has the ability to display a history of exam notes created by multiple users who access a particular exam. In a PACS, a number of people access the same exam information to share their notes and use exam notes as a means of communication. For example, a technologist many enter comments for a radiologist to view. A radiologist may put comments for a clinician to view and visa versa. A user may print exam notes data from this dialog.

FIG. 1B illustrates a key image note dialog in a current PACS system. The key image note functionality provides the ability to create a note for a number of categories. Each key image note created can be associated with a number of key images that are relevant to the key image note. A user may print key image note text from this dialog.

FIG. 1C illustrates a report display dialog in a current PACS system. The report display functionality provides the ability to create and/or show a diagnostic report that radiologists create after review. The report may include a course of treatment, for example. A user may print the report from this dialog.

FIG. 1D illustrates a significant image export dialog in a current PACS system. The significant image export functionality provides the ability to export significant images to a local hard drive, for example. A user may export an image in JPEG, TIFF, PNG, or GIF format, for example.

FIG. 1E illustrates a patient historical data dialog in a current PACS system. The patient historical data dialog shows the list of prior studies or scans made for a particular patient. This dialog may allow a user to print or export the patient historical data.

Current systems, however, do not provide a mechanism to generate a consolidated report of a particular study including all of above information. Rather, a user will have to locate and then print or export each piece of information one by one.

It is highly desirable to export this information into a single, consolidated location or document in many circumstances. For example, a consolidated export of patient and/or study information would be a useful functionality for an academic institution where a user may export data for teaching purpose. As another example, exporting patient and/or study information may be useful for a clinician to extract the information needed for record keeping purpose or to share with patients.

Thus, there is a need for systems and methods for patient and study data export from a PACS database.

### BRIEF SUMMARY OF THE INVENTION

Certain embodiments of the present invention provide a user interface including a representation of a plurality of data items and an export control. Each data item in the plurality of data items represents at least one of patient information and study information stored in a picture archiving and communication system (PACS). The export control allows a user to export one or more of the plurality of data items.

Certain embodiments of the present invention provide a method for exporting data in a picture archiving and communication system (PACS) including displaying a plurality of data items, determining a set of selected data items, and exporting the data items in the set of selected data items to a single file. Each data item in the plurality of data items represents at least one of patient information and study information stored in a PACS. The set of selected data items includes at least one of the plurality of data items.

Certain embodiments of the present invention provide a computer-readable medium including a set of instructions for execution on a computer, the set of instructions including a display routine, a selection routine, and an export routine. The display routine is configured to display a plurality of data items. Each data item in the plurality of data items represents at least one of patient information and study information stored in a picture archiving and communication system (PACS). The selection routine is configured to determine a set of selected data items. The set of selected data items includes at least one of the plurality of data items. The export routine is configured to export the data items in the set of selected data items to a single file.

### BRIEF DESCRIPTION OF SEVERAL VIEWS OF THE DRAWINGS

FIG. 1A illustrates an exam notes dialog in a current PACS system.

FIG. 1B illustrates a key image note dialog in a current PACS system.

FIG. 1C illustrates a report display dialog in a current PACS system.

FIG. 1D illustrates a significant image export dialog in a current PACS system.

FIG. 1E illustrates a patient historical data dialog in a current PACS system.

FIG. 2 illustrates a user interface according to an embodiment of the present invention.

FIGS. 3A-C illustrate a file including exported data items according to an embodiment of the present invention.

FIG. 4 illustrates a flow diagram for a method for exporting data in a PACS according to an embodiment of the present invention.

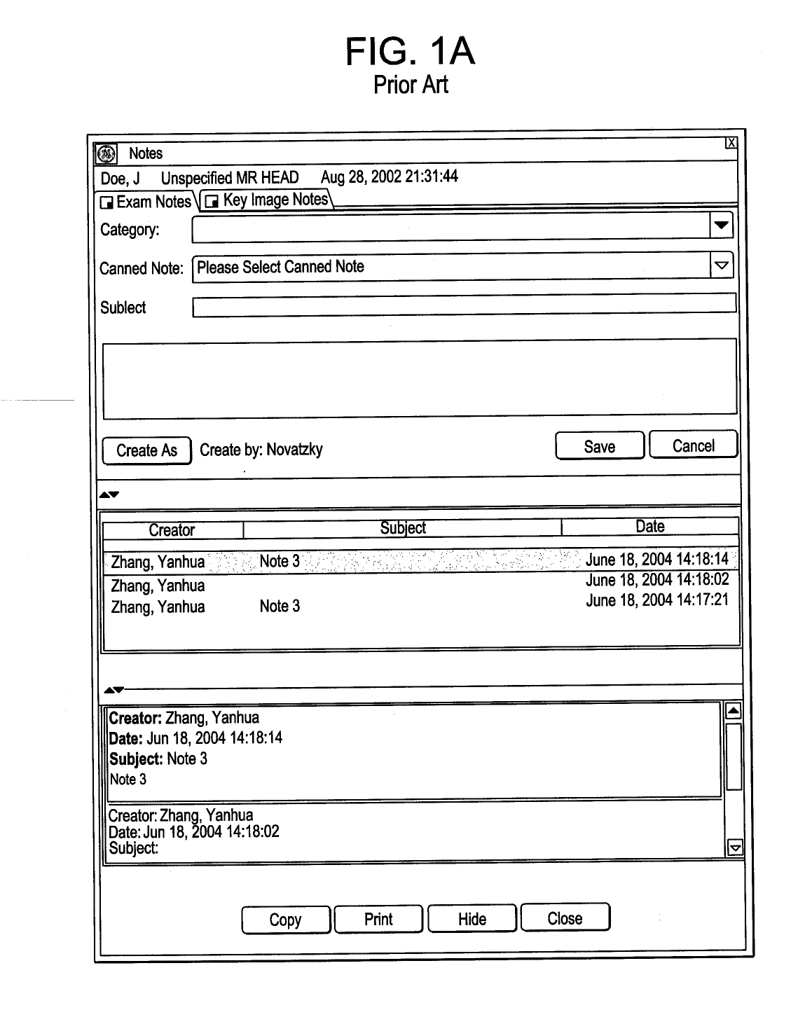

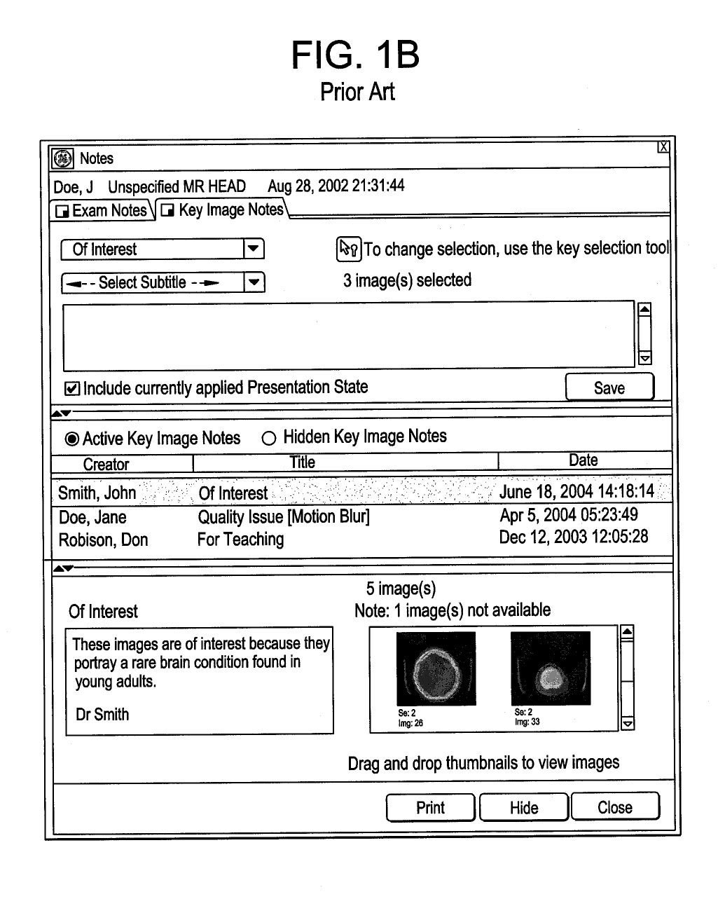

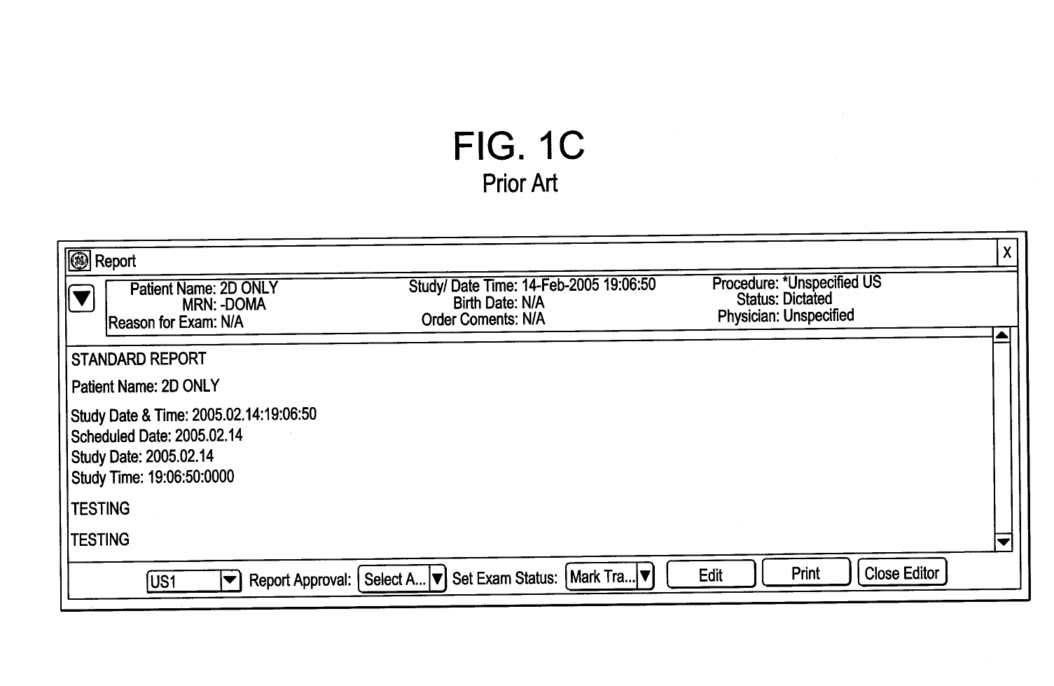

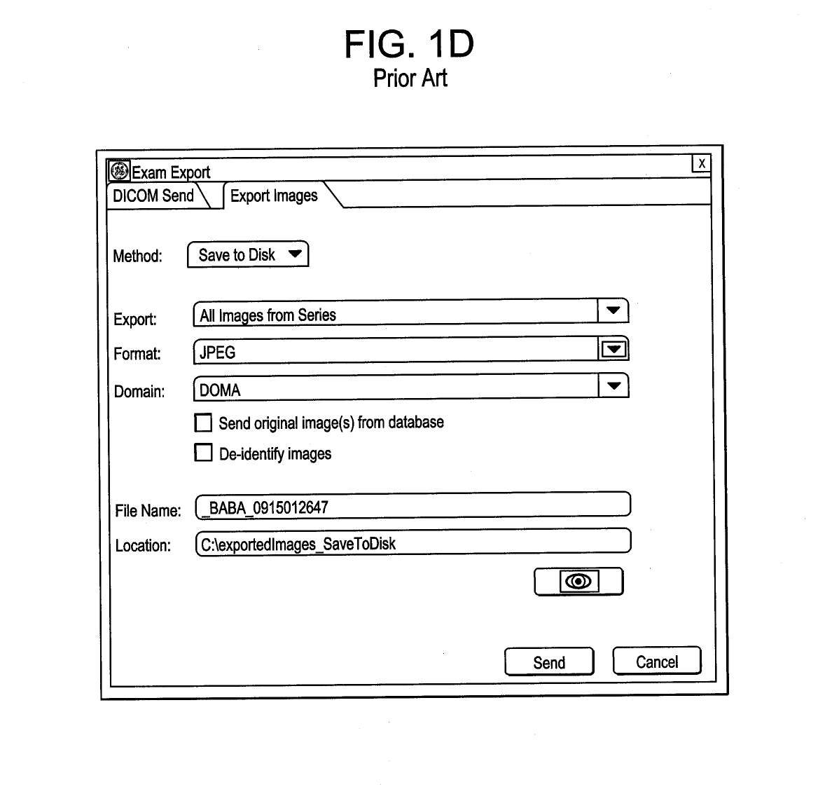

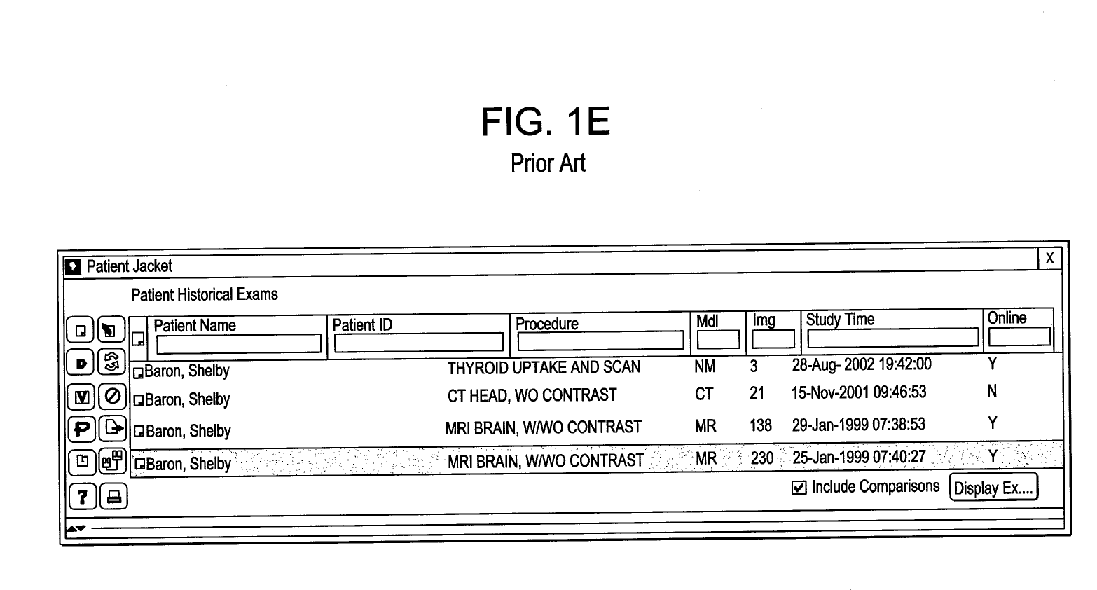

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

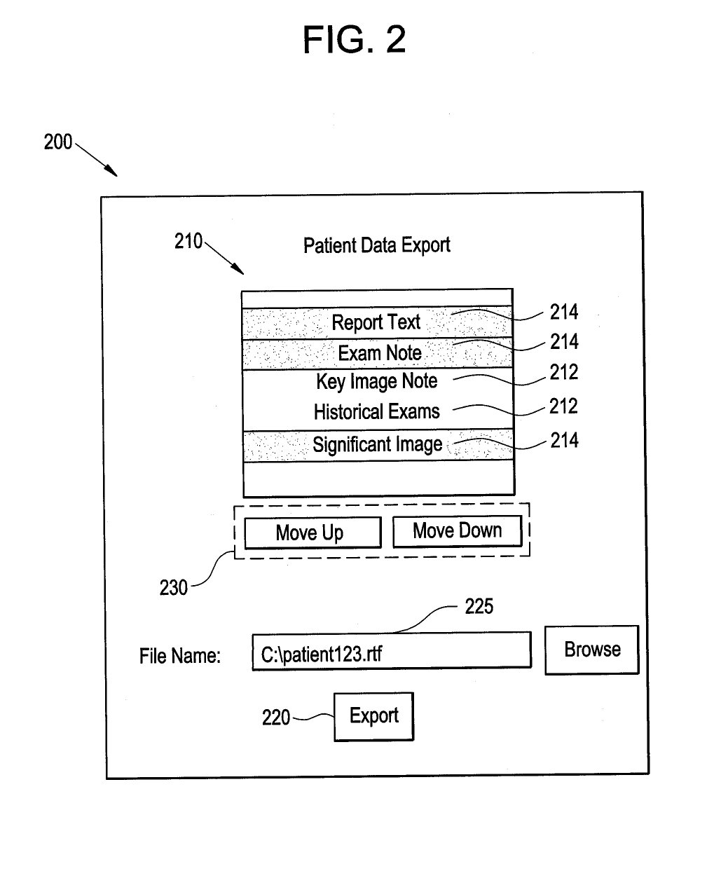

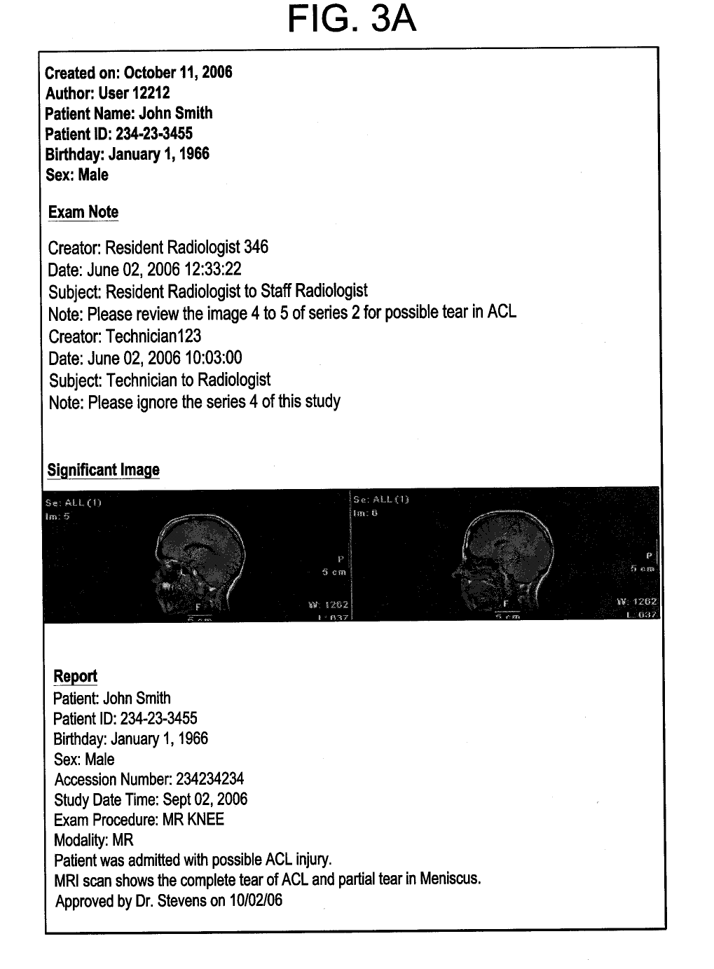

FIG. 2 illustrates a user interface 200 according to an embodiment of the present invention. The user interface includes a display control 210 and an export control 220.

In operation, the display control 210 provides a representation of one or more data items to a user. The data items represent patient and/or study information. The patient and/or study information may be stored in a clinical information system such as a PACS, for example. The data items may represent reports and corresponding text, exam notes, key image notes and text, key images, significant images, patient historical exam data, and screen captures of a monitor view, for example.

As illustrated in FIG. 2, the display control 210 presents a list of data items including “Report Text,” “Exam Note,” “Key Image Note,” “Historical Exams,” and “Significant Image.” Each data item may correspond to one or more pieces of patient and/or study information, for example. For example, “Exam Note” may refer to one or more exam notes associated with the patient or a particular exam or set of exams. As another example, “Key Image Note” may include both key image note text and the associated key images.

The display control 210 is illustrated as a list, but other representations of the one or more data items are possible. For example, the display control 210 may represent a data item as an icon, picture, text, and/or check boxes. An icon or picture may include a thumbnail of the information represented by the data item, for example.

In certain embodiments, the display control 210 is adapted to support the selection of one or more data items. For example, a user may select one or more data items presented by the display control 210. As illustrated in FIG. 2, for example, the display control 210 presents the selected data items 214 to the user by shading them. The unselected data items 212 are not shaded when presented by the display control 210. The selected data items 214 are “Report Text,” “Exam Note,” and “Significant Image.” The unselected data items 212 are “Key Image Note” and “Historical Exams.” A user may select or unselect a data item in the list by clicking on it with a pointing device such as a mouse or touch screen, for example.

Other embodiments may use different representations for selected data items 214 and unselected data items 212. For example, the color of the data item may differentiate selected and unselected data items. As another example, the display control 210 may include two lists of data items, those on the left being unselected data items 212, and those on the right being selected data items 214.

In certain embodiments, the selection of data items is handled by a selection control. The selection control is adapted to support the selection of one or more data items. That is, the selection control allows a user to select one or more of the data items. The selection control may be separate from the display control 210. For example, the selection control may include check boxes next to a list of data items displayed by the display control 210. Alternatively, the selection control may be included in the display control 210, as described above.

In certain embodiments, the selection of data items may be based on a configuration. For example, the initial data items selected may be specified in a global configuration file. In certain embodiments, the selection of data items may be based on a user's preference. For example, a user may specify particular data items to be selected by default. As another example, a user's preferences may indicate a desired order for data items to be included in an exported file.

The export control 220 is adapted to export one or more data items. The data items may be the data items presented by the display control 210, for example. The data items to be exported may include the data items presented by the display control, for example. As another example, the data items to be exported may include the selected data items 214.

In certain embodiments, the export control 220 exports the one or more data items to a single location. The location may be a directory or file, for example. For example, the data items may be exported to a directory on the user's local hard drive. As another example, the data items may be exported to a single file. As another example, the data items may be exported to an email as attachments. As another example, the data items may be exported to a printer to create a single hardcopy. As another example, the data items may be exported to a mobile storage device such as a USB flash drive or recordable optical media.

As mentioned above, the data items may be exported to a single file. The file may be a Rich Text Format (RTF) file, for example. As another example, the file may be a Portable Document Format (PDF) file. As another example, the file may be a Microsoft Word™, Excel™, or PowerPoint™ file. As another example, the file may be a Corel WordPerfect™ or OpenOffice Writer file. As another example, the file may be a Hypertext Markup Language (HTML) file, including links to data items exported as images. As another example, the file may be a graphics file. That is, the data items may be exported to a single image file, such as JPEG, BMP, GIF, and TIFF. Multiple pages of exported data items may be included on separate pages within a single TIFF file, for example.

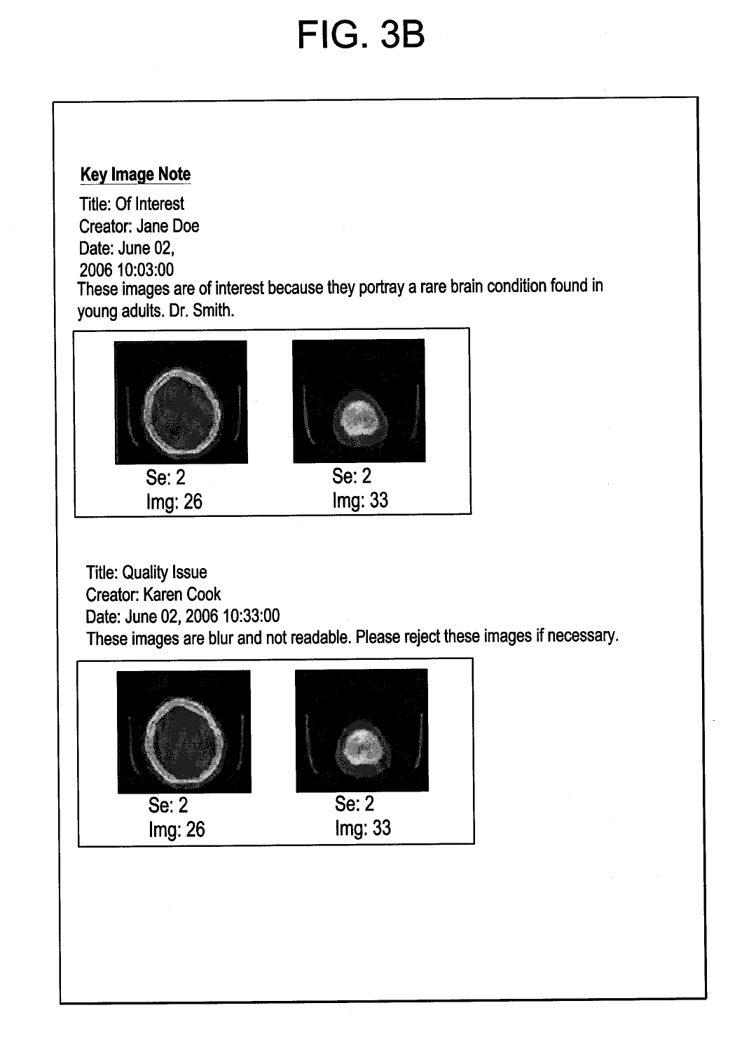

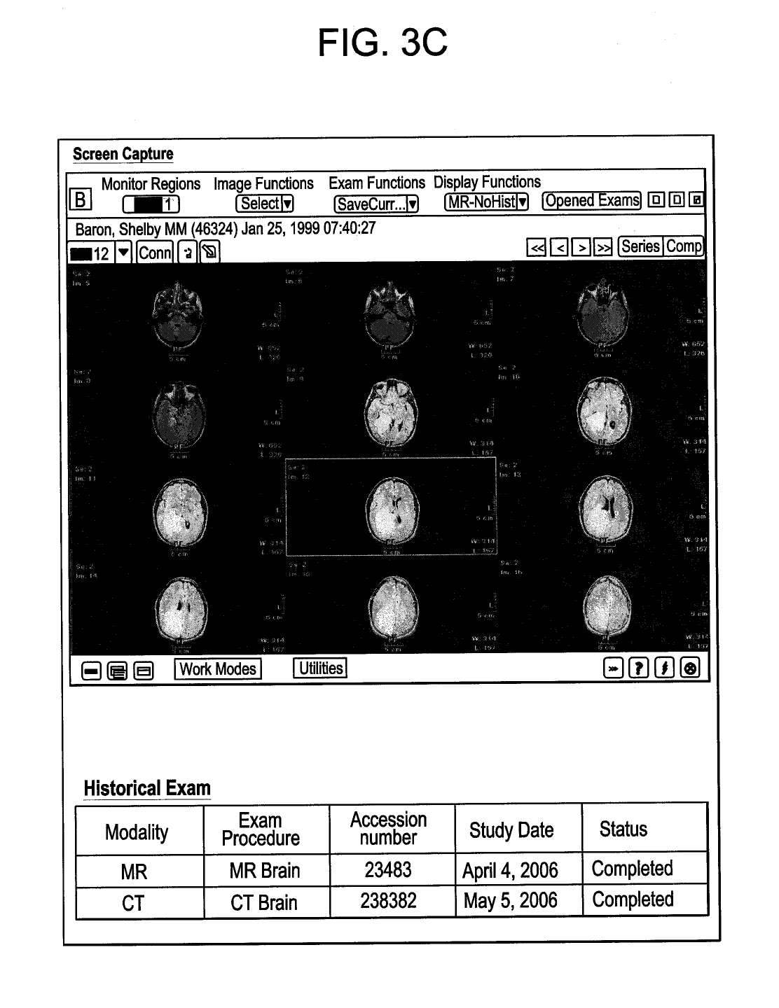

FIGS. 3A-C illustrate a file including exported data items according to an embodiment of the present invention. As illustrated in FIGS. 3A-C, the file includes both text and images.

In certain embodiments, the export control 220 may include an export location identifier 225. The export location identifier 225 may be a path or filename for the exported data items, for example. As another example, the export location identifier 225 may specify a printer for printing the data items.

In certain embodiments, data items may be exported based on a configuration. For example, a global configuration file may indicate that image data items are to be exported in TIFF format. As another example, a user may indicate a preference that data items be exported as a PDF file into a particular directory with a filename including the patient's last name and the date of the export.

In certain embodiments of the present invention, the user interface 200 includes an ordering control 230. The ordering control 230 is adapted to allow the data items presented by the display control 210 to be reordered. That is, the ordering control allows a user to adjust the order of the data items. For example, the ordering control 230 may allow a user to move a particular data item in the display control 210 up or down in the list.

The export control 230 may be adapted to export the data items in the order represented by the display control 210, for example. As another example, the export control 230 may be adapted to export the data items based on the order determined by the ordering control 230.

In certain embodiments, the ordering control 230 is included in the display control 210. For example, a user may drag and drop a data item in the display control 210 to a new location to affect a new order for the data items.

The components, elements, and/or functionality of user interface 200 may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device, such as, for example, a PACS workstation or one or more dedicated processors.

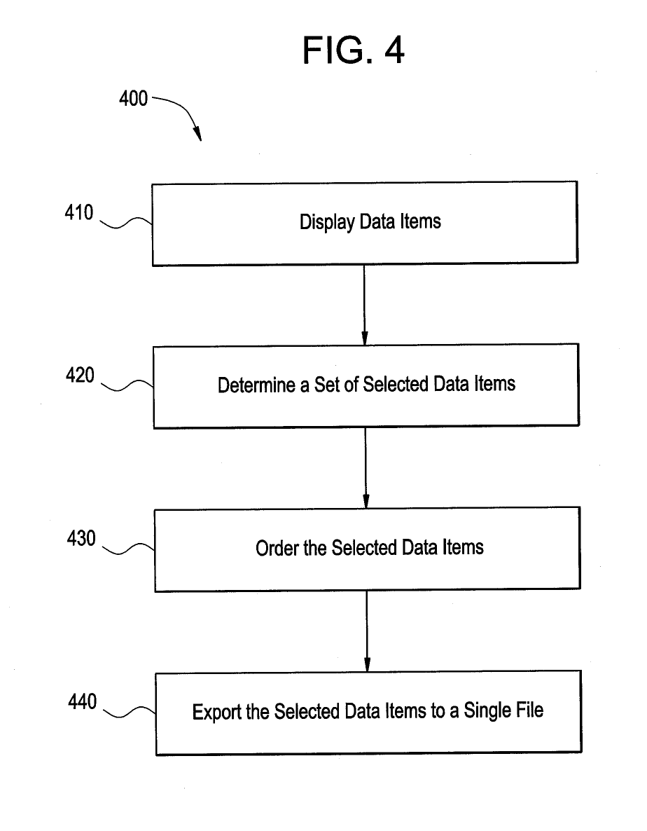

FIG. 4 illustrates a flow diagram for a method 400 for exporting data in a PACS according to an embodiment of the present invention. The method 400 includes the following steps, which will be described below in more detail. At step 410, data items are displayed. At step 420, a set of selected data items is determined. At step 430, the selected data items are ordered. At step 440, the selected data items are exported to a single file. The method 400 is described with reference to elements of systems described above, but it should be understood that other implementations are possible.

At step 410, data items are displayed. The data items may be similar to the data items described above, for example. The data items may be displayed by a display control. The display control may be similar to the display control 210, described above, for example.

The data items represent patient and/or study information. The patient and/or study information may be stored in a clinical information system such as a PACS, for example. The data items may represent reports and corresponding text, exam notes, key image notes and text, key images, significant images, patient historical exam data, and screen captures of a monitor view, for example.

The data items may be displayed as a list. Each data item may correspond to one or more pieces of patient and/or study information, for example. The data items may be displayed by other representations. For example, the data items may be represented by an icon, picture, text, and/or check boxes. An icon or picture may include a thumbnail of the information represented by the data item, for example.

At step 420, a set of selected data items is determined. The data items may be the data items displayed at step 410, described above, for example. The data items may be selected by a user. For example, a user may select one or more data items presented by a display control similar to display control 210, described above. A user may select or unselect data items by clicking on them with a pointing device such as a mouse or touch screen, for example. As another example, the set of selected data items may be determined by placing the data items in one of two lists. For example, the display control may include two lists of data items, those on the left being unselected data items, and those on the right being selected data items.

In certain embodiments, the selection of data items is handled by a selection control. The selection control is adapted to support the selection of one or more data items. That is, the selection control allows a user to select one or more of the data items. The selection control may be separate from the display control 210. For example, the selection control may include check boxes next to a list of data items displayed by the display control 210. Alternatively, the selection control may be included in the display control 210, as described above.

In certain embodiments, the selection of data items may be based on a configuration. For example, the initial data items selected may be specified in a global configuration file. In certain embodiments, the selection of data items may be based on a user's preference. For example, a user may specify particular data items to be selected by default. As another example, a user's preferences may indicate a desired order for data items to be included in an exported file.

At step 430, the selected data items are ordered. The selected data items may be the set of selected data items determined at step 420, described above, for example. The selected data items may be ordered by an ordering control. The ordering control may be similar to the ordering control 230, described above, for example. The ordering control allows a user to adjust the order of the data items. For example, a user may use the ordering control to move a particular data item up or down in a list of data items.

At step 440, the selected data items are exported to a single file. The selected data items may be the set of selected data items determined at step 420, described above, for example. The selected data items may be the selected data items ordered at step 430, described above, for example. The selected data items may be exported by an export control. The export control may be similar to the export control 220, described above, for example.

The selected data items are exported to a single file. For example, the data items may be exported to a file on the user's local hard drive. As another example, the data items may be exported to an email as an attachment. As another example, the data items may be exported to a printer to create a single hardcopy. As another example, the data items may be exported to a mobile storage device such as a USB flash drive or recordable optical media.

As mentioned above, the file may be a Rich Text Format (RTF) file, for example. As another example, the file may be a Portable Document Format (PDF) file. As another example, the file may be a Microsoft Word™, Excel™, or PowerPoint™ file. As another example, the file may be a Corel WordPerfect™ or OpenOffice Writer file. As another example, the file may be a Hypertext Markup Language (HTML) file, including links to data items exported as images. As another example, the file may be a graphics file. That is, the data items may be exported to a single image file, such as JPEG, BMP, GIF, and TIFF. Multiple pages of exported data items may be included on separate pages within a single TIFF file, for example.

In certain embodiments, data items may be exported based on a configuration. For example, a user may indicate a preference that data items be exported as a PDF file into a particular directory with a filename including the patient's last name and the date of the export.

One or more of the steps of the method 400 may be implemented alone or in combination in hardware, firmware, and/or as a set of instructions in software, for example. Certain embodiments may be provided as a set of instructions residing on a computer-readable medium, such as a memory or hard disk, for execution on a computer or other processing device, such as, for example, a PACS workstation.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Thus, certain embodiments of the present invention provide systems and methods for patient and study data export from a PACS database. Certain embodiments provide a technical effect of patient and study data export from a PACS database.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A user interface including:
a representation of a plurality of data items, wherein each data item in the plurality of data items represents at least one of patient information and study information stored in a picture archiving and communication system (PACS);
an export control, wherein the export control allows a user to export one or more of the plurality of data items.

2. The user interface of claim 1, wherein the plurality of data items includes an image.

3. The user interface of claim 1, wherein the plurality of data items includes a screen capture.

4. The user interface of claim 1, wherein the plurality of data items includes historical data.

5. The user interface of claim 1, further including an ordering control, wherein the ordering control allows a user to adjust the order of the plurality of data items.

6. The user interface of claim 5, wherein the exported data items are exported based on the order determined by the ordering control.

7. The user interface of claim 1, further including a selection control, wherein the selection control allows a user to select one or more of the plurality of data items.

8. The user interface of claim 7, wherein the selected data items are exported by the export control.

9. The user interface of claim 1, wherein the exported data items are exported to a single file.

10. A method for exporting data in a picture archiving and communication system (PACS), the method including:
displaying a plurality of data items, wherein each data item in the plurality of data items represents at least one of patient information and study information stored in a PACS;
determining a set of selected data items, wherein the set of selected data items includes at least one of the plurality of data items; and
exporting the data items in the set of selected data items to a single file.

11. The method of claim 10, wherein the set of selected data items is determined based at least in part on input from a user.

12. The method of claim 10, wherein the set of selected data items is determined based at least in part on a preference of a user.

13. The method of claim 10, wherein the exported data items are exported to a location based at least in part on input from a user.

14. The method of claim 10, wherein the exported data items are exported to a location based at least in part on a preference of a user.

15. The method of claim 10, further including ordering the selected data items, wherein the exported data items are exported based on the order of the selected data items.

16. The method of claim 10, wherein the single file is a RTF format file.

17. The method of claim 10, wherein the single file is a PDF file.

18. A computer-readable medium including a set of instructions for execution on a computer, the set of instructions including:
a display routine configured to display a plurality of data items, wherein each data item in the plurality of data items represents at least one of patient information and study information stored in a picture archiving and communication system (PACS);
a selection routine configured to determine a set of selected data items, wherein the set of selected data items includes at least one of the plurality of data items; and
an export routine configured to export the data items in the set of selected data items to a single file.

19. The set of instructions of claim 18, wherein the set of selected data items is determined based at least in part on input from a user.

20. The set of instructions of claim 18, further including an ordering routine configured to allow the set of selected data items to be arranged in a particular order, wherein the exported data items are exported based on the order of the selected data items.
